(19) United States
(12) Patent Application Publication
(10) Pub. No.: US 2026/0249447 A1
(43) Pub. Date: Aug. 27, 2026

(54) DRIVE DEVICE AND ROBOT EQUIPPED WITH DRIVE DEVICE

(71) Applicant: FANUC CORPORATION, Yamanashi (JP)

(72) Inventors: Hidetoshi UEMATSU, Yamanashi (JP); Keitarou INAGAKI, Yamanashi (JP); Taichi TAGUCHI, Yamanashi (JP)

(21) Appl. No.: 18/878,075

(22) PCT Filed: Jul. 14, 2022
(86) PCT No.: PCT/JP2022/027730

§ 371 Date: Dec. 23, 2024

(51) Int. Cl. B25J 9/12; B25J 13/08; B25J 19/00; H02K 11/33

(52) U.S. Cl. CPC B25J 9/126; B25J 13/088; B25J 19/0004; H02K 11/33

(57) ABSTRACT

This drive device comprises: an electric motor unit that includes an electric motor; and an amplifier that supplies current to the electric motor. The amplifier includes a plurality of electrical components that are fixed to a substrate. The amplifier is fixed coaxially to an end section of the electric motor unit in the direction of the rotating shaft of the electric motor. The amplifier is formed so as to be capable of being detached from the electric motor unit through manipulation by a worker.

### RELATED APPLICATIONS

The present application is a National Phase of International Application No. PCT/JP2022/027730 filed Jul. 14, 2022.

### TECHNICAL FIELD

The present invention relates to a drive device and a robot including the drive device.

### BACKGROUND ART

A robot device may be provided with a robot including a joint where an orientation of a component such as an arm changes. The robot device can perform operations while changing the position and orientation of operation tools by driving the components of the robot. A drive device including a decelerator and an electric motor for moving the components are arranged in the robot (e.g., Japanese Unexamined Patent Publication No. 9-29671 A). When the robot includes a joint, a drive device for moving the components may be arranged in the joint. The drive device may be arranged for each joint (e.g., Japanese Unexamined Patent Publication No. 2019-84607 A).

### CITATION LIST

### Patent Literature

PTL 1: Japanese Unexamined Patent Publication No. 9-29671 A

PTL 2: Japanese Unexamined Patent Publication No. 2019-84607 A

### SUMMARY OF INVENTION

### Technical Problem

A current generated based on an operation command of the robot is supplied to the electric motor of the drive device. The current supplied to the electric motor is generated by an amplifier. The amplifier may be arranged in the drive device in addition to the electric motor and the decelerator. When a plurality of drive devices are arranged, the amplifier may be arranged for each drive

An electric circuit of the amplifier includes electric components such as a processor and a power device. In addition, cables such as a power cable that receives electric power from outside and a communication cable that receives an operation command from the robot controller are connected to the amplifier. The cable is connected to a substrate of the amplifier through a connector.

In this regard, the electric components of the amplifier include an electric component that has a high height when arranged on the substrate. For example, a rod-shaped capacitor has a longitudinal direction, and as such has a high height when attached to a substrate. In addition, a connector connected to a wire body such as a cable is inserted to a connector of the substrate. The connector has a high height when attached to the substrate. With such electric components, the amplifier has a high height. The drive device including the amplifier needs to have a space for arranging tall electric components such as a capacitor and a connector. This poses the problem that the drive device becomes long and large.

### Solution to Problem

A drive device according to an aspect of the present disclosure includes an electric motor unit including an electric motor, and an electric motor control unit configured to supply a current to the electric motor. The electric motor control unit includes a substrate having a plate shape, and a plurality of electric components fixed to the substrate. The substrate is arranged so as to intersect an extending direction of a rotation axis of the electric motor. The plurality of electric components include a specified electric component with a longitudinal direction provided upright from the substrate. The specified electric component is fixed in a direction protruding from the substrate toward an inner side of the drive device and is arranged more outward than the electric motor unit in a radial direction.

A robot of the present disclosure includes the above-described drive device, and a joint configured to rotate one component with respect to another component. The drive device is arranged at the joint.

### Advantageous Effects of Invention

According to an aspect of the present disclosure, a small-sized drive device and a robot including the drive device can be provided.

### BRIEF DESCRIPTION OF DRAWINGS

FIG. 1 is a perspective view of a robot according to an embodiment.

FIG. 2 is a schematic sectional view of a drive device of the embodiment.

FIG. 3 is an electric circuit diagram of an amplifier according to the embodiment.

FIG. 4 is a schematic perspective view of the amplifier.

FIG. 5 is a schematic plan view of the amplifier.

FIG. 6 is a schematic plan view of a power substrate of the amplifier of the embodiment.

FIG. 7 is a schematic plan view of a control substrate of the amplifier of the embodiment.

FIG. 8 is an enlarged schematic sectional view of a drive device including an amplifier according to a comparative example.

FIG. 9 is an enlarged schematic sectional view of a joint of a robot where the drive device is arranged.

### DESCRIPTION OF EMBODIMENTS

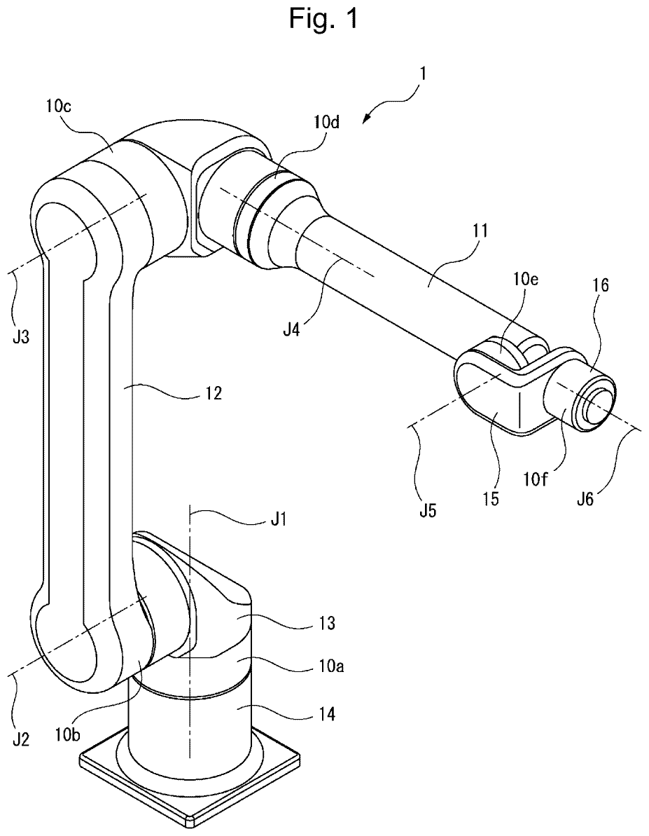

With reference to FIG. 1 to FIG. 9, a drive device and a robot including the drive device of an embodiment are described below. The drive device of the present embodiment rotates one component of the robot with respect to another component around a predetermined rotation axis.

FIG. 1 is a perspective view of a robot of the present embodiment. A robot 1 of the present embodiment is an articulated robot including a plurality of joints 10a to 10f. The robot 1 of the present embodiment is a cooperative robot that can operate in conjunction with the operator. The cooperative robot is configured such that when a predetermined external force acts on the robot 1, the operation of the robot 1 is limited.

The robot 1 includes a plurality of components that are rotatable at the joints 10a to 10f. The components are formed so as to rotate around drive axes J1 to J6 serving as the rotation axes. The drive device of the present embodiment is arranged inside the joints 10a to 10f so as to drive the components of the robot 1. The robot of the present embodiment has six drive axes, but is not limited to this configuration. Robots that change the position and orientation with given mechanisms may be employed.

The robot 1 of the present embodiment includes, as the components of the robot 1, a base part 14, a turning base 13, an upper arm 12, a front arm 11, and a wrist 15. The turning base 13 rotates around the drive axis J1 with respect to the base part 14 fixed to the installation surface. The upper arm 12 rotates around the drive axis J2 with respect to the turning base 13. The front arm 11 rotates around the drive axis J3 with respect to the upper arm 12. Further, the front arm 11 rotates around the drive axis J4 that is parallel to the extending direction of the front arm 11. The robot 1 includes the wrist 15 supported by the front arm 11. The wrist 15 rotates around the drive axis J5. In addition, the wrist 15 includes a flange 16 that rotates around the drive axis J6. An operation tool corresponding to the operation performed by the robot device is fixed to the flange 16.

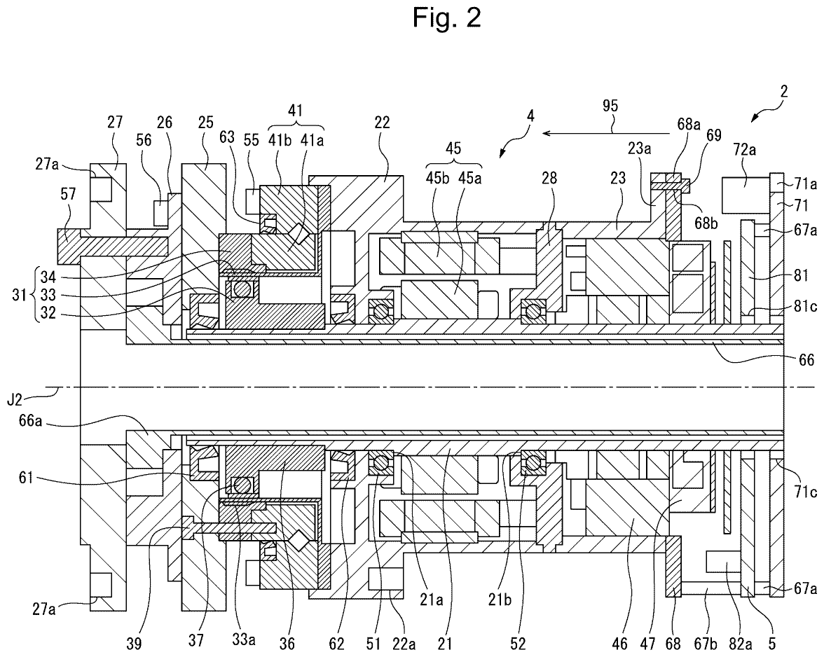

FIG. 2 is a sectional view of the drive device of the present embodiment. With reference to FIG. 1 and FIG. 2, in the robot 1 of the present embodiment, a drive device is arranged for each of the joints 10a to 10f. In other words, one drive device is arranged for each joint. In the present embodiment, the drive device 2 for rotating the upper arm 12 around the drive axis J2 with respect to the turning base 13 is described as an example. The drive device 2 is arranged at the joint 10b. The drive device 2 is fixed to the housing of the turning base 13 and the housing of the upper arm 12. The drive device 2 is arranged such that the direction indicated by an arrow 95 is the direction toward the turning base 13, for example.

The drive device 2 includes an electric motor 45 including a rotor 45a and a stator 45b. The drive axis J2 corresponds to the rotation axis of the electric motor 45 and the axial direction of the drive device 2. The rotor 45a is fixed to a shaft 21. The shaft 21 that transmits the rotational force of the electric motor 45 serves as an output shaft of the electric motor 45. The shaft 21 of the present embodiment is a hollow shaft having a cylindrical shape. The shaft 21 rotates with the drive axis J2 as a rotation axis.

The drive device 2 includes a torque sensor 27 that detects a torque output from the drive device 2. The torque sensor 27 detects a torque around the drive axis J2 when the drive device 2 is driven. The robot controller receives a signal related to a torque through a communication cable serving as a communication line. The robot controller subtracts the moment related to the own weight of the robot and the moment related to the operation of the robot from the torque detected at the torque sensor. The calculated moment corresponds to the external force applied to the robot.

The robot of the present embodiment is a cooperative robot. When the external force is greater than a predetermined determination value, the robot controller can limit the operation of the robot. For example, when the operator touches the robot, the external force to be detected increases. When the external force becomes greater than a determination value, the controller of the robot can stop the robot. The drive device of the present embodiment includes the torque sensor, but is not limited to this configuration. The torque sensor need not be arranged in the drive device.

A flange 26 is fixed to the torque sensor 27 with a bolt 57. A flange 25 is fixed to the flange 26 with a bolt 56. In the present embodiment, the torque sensor 27 and the flanges 25 and 26 are fixed to a housing 13a of the turning base 13. The torque sensor 27 and the flanges 25 and 26 are members that are immovable with respect to the housing 13a.

The drive device 2 includes an electric motor unit 4 including the electric motor 45. The electric motor unit 4 may include at least one device selected from a group of a decelerator, a brake, and a rotation position detector. The devices are arranged side by side in the direction along the rotation axis of the electric motor 45. The electric motor unit 4 of the present embodiment includes a decelerator 31 that amplifies the rotational force of the electric motor 45, an electromagnetic brake 46 serving as a brake for the shaft 21, an encoder 47 serving as a rotation position detector that detects the rotation position of the electric motor 45, and the torque sensor 27. The torque sensor 27, the decelerator 31, the electric motor 45, the electromagnetic brake 46, and the encoder 47 are arranged in a row in this order. It should be noted that at least one selected from a group of the torque sensor, the decelerator, the electromagnetic brake, and the encoder need not be arranged in the electric motor unit.

The drive device 2 includes a housing 22 with the electric motor 45 arranged inside. The housing 22 of the present embodiment is fixed to the housing of the upper arm 12. The shaft 21 is supported at bearings 51 and 52 in a rotatable manner. The drive device 2 includes a housing 23 with the electromagnetic brake 46 arranged inside. The housing 22 and the housing 23 are fixed to each other with a fastening member such as a bolt. In addition, a bearing fixing member 28 for fixing the bearing 52 is arranged between the housing 22 and the housing 23. The bearing fixing member 28 is fixed to the housing 23 with a fastening member such as a bolt. The housings 23 and 22 and the bearing fixing member 28 can be detached from the side opposite to the direction indicated by the arrow 95 by detaching the fastening member.

A protective tube 66 is arranged at an inner side of the shaft 21. The protective tube 66 is formed in a cylindrical shape along the inner surface of the shaft 21. A wire body such as an electric wire such as a power cable, an air tube that supplies compression air, or a communication cable is inserted inside the protective tube 66. The protective tube 66 is fixed with a nipping portion 66a sandwiched by the flange 26 and the torque sensor 27. When the protective tube 66 is arranged, the wire body can be arranged inside the joint 10b of the robot 1.

The shaft 21 of the present embodiment includes a step part 21a and a step part 21b for restricting the movement in the extending direction of the rotation axis of the shaft 21. The bearings 51 and 52 are engaged with the step part 21a and the step part 21b. The bearing 51 is fixed by the housing 22, and the bearing 52 is fixed by the bearing fixing member 28.

The decelerator 31 of the drive device 2 transmits the rotational force output by the electric motor 45 to the housing 22. The decelerator 31 of the present embodiment is a wave gear decelerator. The decelerator 31 includes a wave generation member 32 serving as an input part where the rotational force is input. The wave generation member 32 is referred to as a wave generator. The wave generation member 32 includes a hub 36 whose shape (planar shape) as viewed from the direction of the rotation axis is an ellipse shape, and a ball bearing 37 arranged at the outer peripheral surface of the hub 36. The hub 36 serves as a cam having an ellipse planar shape. The hub 36 is fixed to the shaft 21 by means of key coupling or the like, for example.

The decelerator 31 includes an elastic cylindrical member 33 that is elastically deformable. The elastic cylindrical member 33 is arranged at an outer side of the wave generation member 32. The elastic cylindrical member 33 is referred to as a flexspline. The elastic cylindrical member 33 includes a plurality of first tooth parts 33a formed at the outer peripheral surface. The elastic cylindrical member 33 is formed so as to deform along with the rotation of the hub 36. The elastic cylindrical member 33 of the present embodiment is fixed to the housing 22 with a bolt 55. The elastic cylindrical member 33 serves as an output part of the decelerator 31.

The decelerator 31 includes an annular member 34 arranged at an outer side of the elastic cylindrical member 33. The annular member 34 is referred to as a circular spline. The annular member 34 is composed of a rigid member that does not elastically deform. A second tooth part that engages with the first tooth part 33a is formed at the inner peripheral surface of the annular member 34.

A main bearing 41 is arranged on the lateral side of the annular member 34. The main bearing 41 of the present embodiment is a cross roller bearing. The main bearing 41 includes an inner ring 41a and an outer ring 41b. The inner ring 41a is fixed to the flange 25 and the annular member 34 with a bolt 39. The outer ring 41b is fixed to the elastic cylindrical member 33 together with the housing 22 with the bolt 55. In the present embodiment, the wave generation member 32 rotates, but the annular member 34 is fixed so as not to rotate.

Since the hub 36 of the wave generation member 32 has an elliptical shape, the first tooth part 33a of the elastic cylindrical member 33 and the second tooth part of the annular member 34 engage with each other in the major axial direction of the ellipse. In this regard, the number of teeth of the first tooth part 33a of the elastic cylindrical member 33 is smaller than the number of teeth of the second tooth part of the annular member 34. For example, the numbers of the teeth differ by two. When the wave generation member 32 rotates one revolution, the elastic cylindrical member 33 slightly rotates by a reduction ratio corresponding to the difference in the number of teeth of the tooth part. The decelerated rotational force is output to the housing 22 and the outer ring 41b of the main bearing 41 fixed to the elastic cylindrical member 33. The housing 22 of the drive device 2 is fixed to the housing of the upper arm 12. In this manner, when the drive device 2 is driven, the upper arm 12 rotates with respect to the turning base 13.

Oil seals 61 and 62 are arranged at the outer peripheral surface of the shaft 21 such that the lubricating oil inside does not leak to the outside, or that entry of foreign matters from the outside is prevented. In addition, an oil seal 63 is arranged such that the lubricating oil inside the main bearing 41 does not leak to the outside, or that entry of foreign matters from the outside is prevented.

The drive device 2 of the present embodiment includes an amplifier 5 serving as an electric motor control unit that supplies current to the electric motor 45. The amplifier 5 is also referred to as a driver for driving the electric motor 45. The amplifier 5 of the present embodiment is arranged at an end portion in the axial direction of the drive device 2. In this example, it is arranged at the endmost among the components making up the drive device 2. The amplifier 5 is arranged coaxially with the electric motor unit 4 including the electric motor 45. The amplifier 5 of the present embodiment receives operation commands from the robot controller, and controls the value and frequency of the current to be supplied to the electric motor 45 based on the operation command. The amplifier 5 includes an electric circuit that generates the current to be supplied to the electric motor 45.

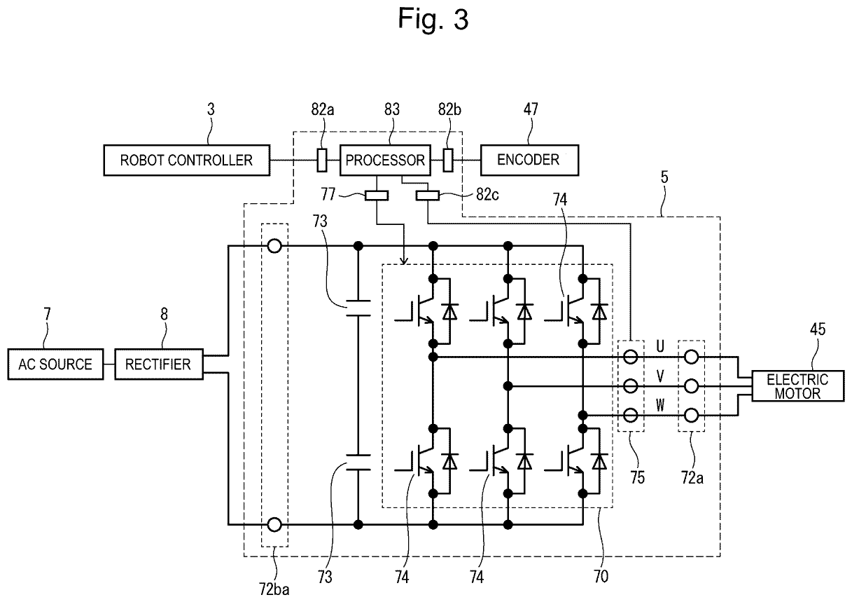

FIG. 3 is an electric circuit diagram illustrating the amplifier of the present embodiment. The robot controller 3 is arranged away from the robot 1, for example. The robot controller includes a computation processing device including a CPU (Central Processing Unit) serving as a processor. The robot controller 3 outputs operation commands to the drive devices arranged in the joints 10a to 10f. The AC current from the AC source 7 is converted to DC current by a rectifier 8. The amplifier 5 of the present embodiment serves as an inverter that converts the DC current from the rectifier 8 to the AC current.

The amplifier 5 includes one or more capacitors 73 for smoothing the DC current. The amplifier 5 includes a main circuit 70 that generates a 3-phase AC current from the DC current. The main circuit 70 is a bridge circuit including a plurality of power devices 74. In the present embodiment, the 3-phase AC current is generated and supplied to the electric motor 45. The main circuit 70 of the present embodiment includes six power devices 74. Examples of the power device 74 may include power semiconductor devices such as a MOSFET (Metal-Oxide-Semiconductor Field-Effect Transistor), an IGBT (Insulated Gate Bipolar Transistor), and an IPM (Intelligent Power Module).

The amplifier 5 includes a processor 83 that outputs operation commands to the power devices 74 of the main circuit 70. As the processor 83 that controls the main circuit 70, any processors such as an MCU (Micro Controller Unit), an LSI (Large Scale Integration) and a CPU (Central Processing Unit) may be employed.

The processor 83 receives the operation command for driving the electric motor 45 from the robot controller 3. The processor 83 receives the output signal of the encoder 47 that detects the rotation position of the electric motor 45. In addition, a current detection sensor 75 is arranged at the power cable output from the main circuit 70. The processor 83 receives the output signal of the current detection sensor 75.

The processor 83 outputs a switching command of a pulse-width modulation control to the main circuit 70 on the basis of the operation command from the robot controller 3. The processor 83 outputs the command for driving each power device 74. At this time, the processor 83 may output commands for controlling the power device 74 on the basis of the output signal of the encoder 47 and the output signal of the current detection sensor 75. Alternatively, the processor 83 may output commands for controlling the power device 74 on the basis of the output signal of the torque sensor 27.

The electric components such as the processor 83, the capacitor 73, and the power device 74 included in the amplifier 5 are arranged on the surface of a substrate included in the amplifier 5. The command from the robot controller 3 is input to the processor through a connector 82a arranged on the substrate. The output signal of the encoder 47 is input to a processor through a connector 82b. The output signal of the current detection sensor 75 is input to the processor 83 through a connector 82c. The command output from the processor 83 is output to the main circuit 70 through a connecting member 77.

In addition, the current converted to the direct current at the rectifier 8 is input to the main circuit 70 through a connector 72ba. Further, the U-phase, V-phase, and W-phase AC currents supplied from the main circuit 70 are supplied to the electric motor 45 through a connector 72a. In this manner, a connector for connecting the wire body to the electric circuit is arranged on the substrate of the amplifier 5. For example, a female connector is fixed to the substrate. Further, a male connector connected to a distal end of the wire body is inserted to or removed from the female connector.

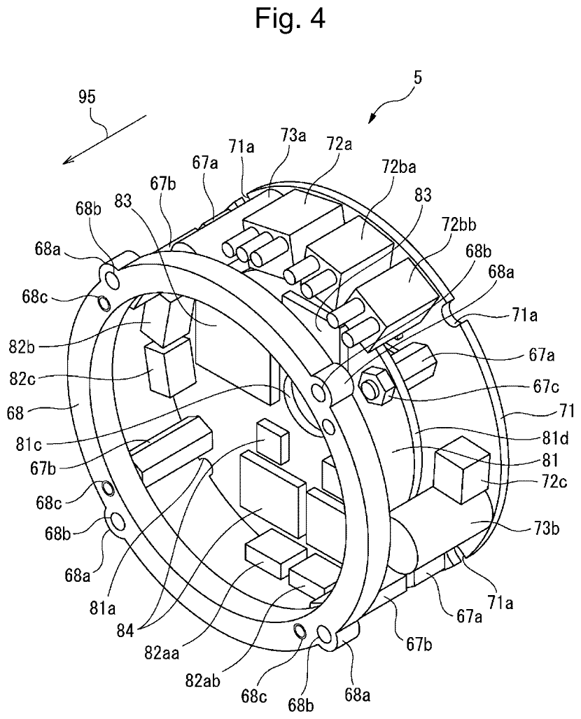

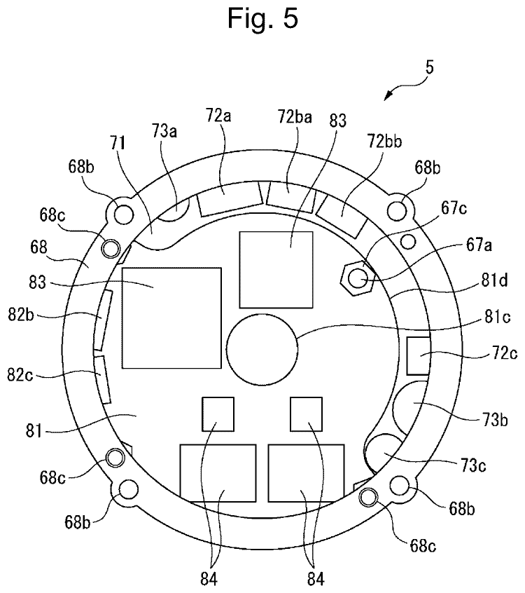

FIG. 4 is a perspective view of the amplifier of the present embodiment. FIG. 5 is a schematic plan view of the amplifier of the present embodiment. With reference to FIG. 2 to FIG. 5, the arrow 95 indicates a direction in which the electric motor 45 is arranged with respect to the amplifier 5. The arrow 95 indicates a direction along the drive axis J2 as the rotation axis of the electric motor 45.

The amplifier includes a plate-shaped substrate, and a plurality of electric components fixed to the substrate. The amplifier 5 of the present embodiment includes a power substrate 71 where electric components for supplying electric power to the electric motor 45 are arranged. The amplifier 5 of the present embodiment includes a control substrate 81 where electric components for generating command signals for controlling the main circuit 70 are arranged. The power substrate 71 and the control substrate 81 are each arranged so as to intersect the extending direction of the drive axis J2. In the present embodiment, the power substrate 71 and the control substrate 81 each have a maximum area surface with the maximum area. The plurality of electric components are arranged in the maximum area surface. The power substrate 71 and the control substrate 81 are arranged such that the maximum area surfaces perpendicularly intersect the drive axis J2. In addition, the power substrate 71 and the control substrate 81 are arranged such that the maximum area surfaces are parallel to each other.

The control substrate 81 is fixed to the power substrate 71 with an interval bolt 67a. The interval bolt 67a includes male screws at both end portions in the axial direction. The interval bolt 67a is fixed to a screw hole 71b formed in the power substrate 71. In addition, one interval bolt 67a fixes the control substrate 81 with a nut 67c. Another interval bolt 67a fixes the control substrate 81 by sandwiching the control substrate 81 with it and an interval bolt 67b.

The control substrate 81 is fixed to a metal fitting 68 through the interval bolt 67b. A male screw is formed at one end portion of the interval bolt 67b of the present embodiment, and a female screw is formed at the other end portion. The male screw of the interval bolt 67a is inserted to the female screw of the interval bolt 67b and fixed. The control substrate 81 is sandwiched by the interval bolt 67a and the interval bolt 67b.

The metal fitting 68 is formed in an annular shape. The metal fitting 68 is a member for fixing the amplifier 5 to the housing 23 of the electric motor unit 4. The metal fitting 68 includes a screw hole 68c for fixing the interval bolt 67b. The interval bolt 67b is fixed with the male screw inserted to the screw hole 68c. In the present embodiment, the power substrate 71, the control substrate 81, and the metal fitting 68 are integrally fixed with the interval bolts 67a and 67b. The interval bolts 67a and 67b serve as spacers for separating a plurality of substrates by a predetermined distance. The method of fixing the plurality of substrates is not limited to this embodiment, and they may be fixed to each other with any members.

The metal fitting 68 includes a protrusion 68a protruding outward in the radial direction. A hole 68b for inserting a bolt 69 is formed in the protrusion 68a. The holes 68b are formed having a predetermined distance therebetween in the circumferential direction. With reference to FIG. 2, a protrusion 23a protruding outward in the radial direction is formed at an end portion of the housing 23 of the electric motor unit 4. A screw hole is formed in the protrusion 23a. The metal fitting 68 is fixed to the protrusion 23a with the bolt 69. In this manner, the amplifier 5 is fixed to the housing 23 with the metal fitting 68.

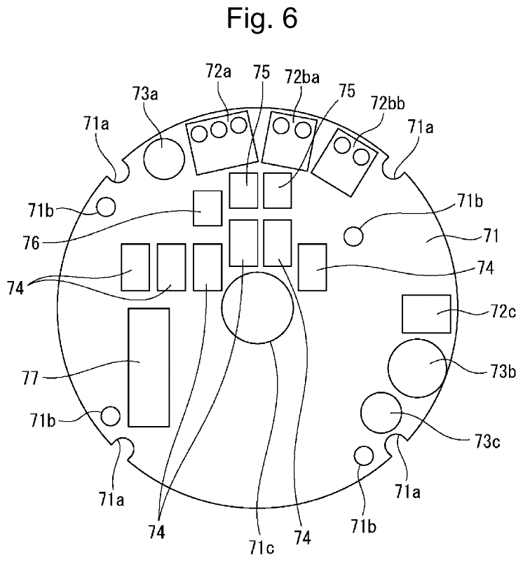

A through hole 71c is formed at a center portion of the power substrate 71. In addition, a through hole 81c is formed at a center portion of the control substrate 81. The shaft 21 and the protective tube 66 are inserted in the through holes 71c and 81c. In the present embodiment, the substrate where the electronic components are arranged is composed of the power substrate and the control substrate, but is not limited to this configuration. The number of the substrate where the electronic component is arranged may be one. Alternatively, three or more substrates may be arranged. Now electronic components arranged on each substrate are described below. FIG. 6 is a schematic plan view of a power substrate of the present embodiment. With reference to FIG. 3, FIG. 4, and FIG. 6, the power substrate 71 is formed in a substantially circular planar shape. An electric component for supplying current to the electric motor 45 is arranged on the power substrate 71.

The screw hole 71b for fixing the interval bolt 67a is formed in the power substrate 71. A recess 71a is formed at the outer periphery of the power substrate 71. The recess 71a is formed corresponding to the position of the bolt 69 for fixing the amplifier 5 to the housing 23. In other words, the recess 71a is formed at a position corresponding to the hole 68b of the metal fitting 68. With the recess 71a thus formed, the operator can operate the bolt 69 for fixing the amplifier 5 to the electric motor unit 4 from an outer side of the robot 1. By detaching the bolt 69, the amplifier 5 can be integrally detached from the electric motor unit 4.

The electric components arranged at the amplifier 5 include an electric component with a longitudinal direction. In other words, an electric component having a slender extended shape is included. Such an electric component has a high height when attached to the substrate surface. In the present embodiment, the electric component with the longitudinal direction provided upright from the maximum area surface of the substrate is referred to as a specified electric component. In addition, an electric component other than the specified electric component is referred to as a normal electric component.

For example, capacitors 73a, 73b and 73c formed in a round columnar shape are arranged on the power substrate 71. The capacitors 73a, 73b and 73c have a function of smoothening DC current. The axial direction of the columnar shape of the capacitors 73a, 73b and 73c is the longitudinal direction. The capacitors 73a, 73b and 73c are arranged such that the longitudinal direction is provided upright from the maximum area surface of the power substrate 71.

The connector 72a for supplying current to the electric motor 45 is arranged on the power substrate 71. The connector 72ba to which a power cable 86a for receiving the current from the rectifier 8 is connected is arranged on the power substrate 71. A connector 72bb to which a power cable 86b for supplying the electric power to other drive devices is connected is arranged on the power substrate 71. In addition, a connector 72c for supplying the electric power to the electromagnetic brake 46 is arranged on the power substrate 71. The connectors 72a, 72ba, 72bb and 72c have longitudinal directions provided upright from the maximum area surface of the power substrate 71. The capacitors 73a, 73b and 73c and the connectors 72a, 72ba, 72bb and 72c

On the other hand, the plurality of power devices 74 included in the main circuit 70 are arranged on the maximum area surface of the power substrate 71. In addition, the current detection sensor 75 for detecting the current output from the main circuit 70 is arranged. Further, a gate processor 76 serving as a processor for supplying the current to the gate of each power device 74 is arranged. The power device 74, the current detection sensor 75, and the gate processor 76 are formed in a plate shape, and as such have a low height from the maximum area surface of the power substrate 71. These electric components do not have the longitudinal direction provided upright from the maximum area surface of the substrate, and therefore correspond to the normal electric component.

In addition, the connecting member 77 for performing communication with the electric circuit of the control substrate 81 is arranged on the power substrate 71. The connecting member 77 is formed so as to fit with the connecting member arranged on the rear surface of the control substrate 81. When the amplifier 5 is assembled, the connecting member 77 of the power substrate 71 and the connecting member of the control substrate 81 fit with each other, and the electric circuits of two substrates are connected to each other. The connecting member 77 corresponds to the normal electric component.

It should be noted that the power device 74 of the present embodiment includes a MOSFET. The power device may include an IGBT. The power device including an IGBT may have a longitudinal direction and a high height. Such a power device corresponds to the specified electric component. Alternatively, as a capacitor, a plate-shaped chip capacitor with a low height may be arranged. The chip capacitor does not have the longitudinal direction provided upright from the substrate, and therefore corresponds to the normal electric component.

In this manner, the specified electric component may include at least one member selected from a group of the capacitor, the power device, and the connector. As the connector, any connectors for connecting the wire body to the substrate may be employed. The specified electric component is arranged along the circumferential direction at the outer peripheral part of the substrate.

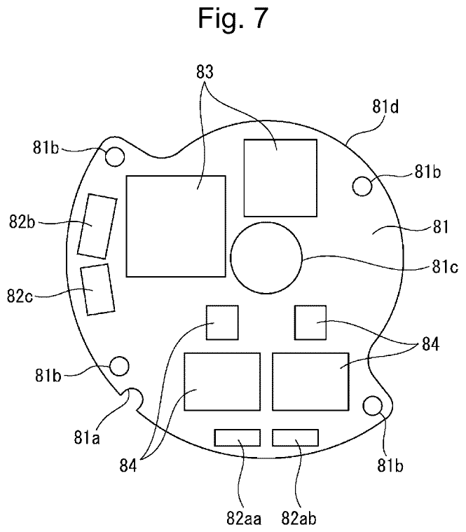

FIG. 7 is a schematic plan view of a control substrate of the present embodiment. With reference to FIG. 3, FIG. 4, and FIG. 7, the control substrate 81 has a shape that is obtained by cutting out a part of the outer periphery from a circular substrate. The control substrate 81 includes a notch 81d. The connectors 72a, 72ba, 72bb and 72c and the capacitors 73a, 73b and 73c of the power substrate 71 are arranged at an outer side of the notch 81d. The control substrate 81 includes a recess 81a. The recess 81a is formed corresponding to the position of the hole 68b of the metal fitting 68. When detaching the amplifier 5 from the electric motor unit 4, the operator operates the bolt 69 arranged in the hole 68b through the recess 81a. In addition, the control substrate 81 includes a hole 81b to which the male screw of the interval bolt 67a is inserted.

In the control substrate 81, an electric component for performing the control is arranged on the maximum area surface. The processor 83 that outputs a command to the main circuit 70 is arranged on the control substrate 81. A processing circuit 84 for processing input data is arranged on the control substrate 81. The processor 83 and the processing circuit 84 are formed in a plate shape. In the present embodiment, the processor 83 and the processing circuit 84 correspond to the normal electric component.

In this case, the plurality of drive devices of the robot 1 of the present embodiment are formed so as to perform serial communication with each other. One drive device is connected to the other drive device through a communication cable. A connector 82aa to which a communication cable 87a for receiving from the other drive device the signal from the robot controller 3 is connected is arranged on the control substrate 81. A connector 82ab to which a communication cable 87b for transmitting the signal from the robot controller 3 to the other drive device is connected is arranged on the control substrate 81.

In addition, the connector 82b to which a signal cable for receiving the signal from the encoder 47 is connected is arranged on the control substrate 81. In addition, the connector 82c to which a signal cable for receiving the signal from the current detection sensor 75 is connected is arranged. Furthermore, a connector to which a signal cable for receiving the signal from the torque sensor 27 is connected may be arranged.

The connectors 82aa, 82ab, 82b and 82c arranged on the control substrate 81 correspond to the specified electric component with the longitudinal direction provided upright from the surface of the substrate. The connectors 82aa, 82ab, 82b and 82c are arranged along the circumferential direction at the outer peripheral part of the control substrate 81.

In this manner, the specified electric component may include at least one connector selected from a group of a connector to which the electric power from the power source is input, a connector to which the operation command of the electric motor is input, a connector to which the information of the sensor is input, a connector for supplying electric power to the electric motor, and a connector for supplying electric power to the brake.

The specified electric component of the present embodiment is arranged at the outer peripheral part of the substrate in the radial direction. The specified electric component is fixed in a direction protruding from each substrate toward an inner side of the drive device in the axial direction. In the present embodiment, the specified electric component is fixed in the direction protruding from each substrate toward a side at which the electric motor 45 is arranged. For example, the connector and the capacitor are arranged so as to protrude in the direction indicated by the arrow 95 from the power substrate 71. In addition, the connector is arranged so as to protrude from the control substrate 81 in the direction indicated by the arrow 95.

With reference to FIG. 2 and FIG. 4, the specified electric components, such as the connectors 72a and 82aa and the capacitor 73a, are arranged more outward than the electric motor unit 4 in the radial direction. More specifically, the specified electric components are arranged more outward than the members included in the electric motor unit 4 in the radial direction.

In this example, the specified electric components, such as the connector 72a and the capacitor 73a arranged on the power substrate 71, are arranged at an outer side of the encoder 47 in the radial direction. In addition, the specified electric component, such as the connector 82b arranged on the control substrate 81, is arranged at the outer side of the encoder 47 in the radial direction. With this configuration, the space for arranging the specified electric component can be ensured at an outer side of the electric motor unit 4, and thus the drive device 2 can be downsized.

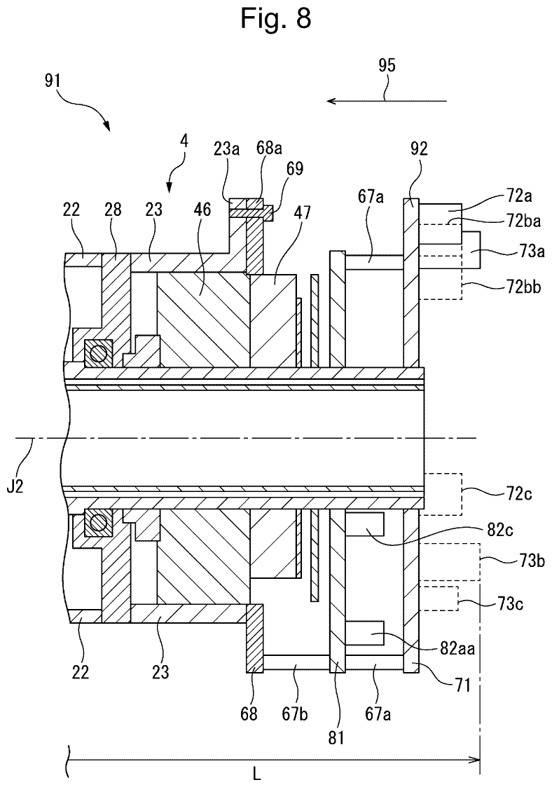

FIG. 8 is an enlarged schematic view of a drive device including an amplifier of a comparative example. The drive device 91 of the comparative example includes an amplifier 92 serving as an electric motor control unit. The amplifier 92 of the comparative example includes the power substrate 71 and the control substrate 81. Each electric component is fixed to the substrate so as to face the outer side of the drive device 91 in the direction of the rotation axis of the drive device 91. In particular, the connectors 72a, 72ba, 72bb and 72c and the capacitors 73a, 73b and 73c serving as the specified electric component are fixed to the power substrate 71 so as to be provided upright in the opposite direction of the direction indicated by the arrow 95. In addition, also in the control substrate 81, the specified electric components, such as the connectors 82aa and 82c, are fixed so as to face the outer side of the drive device 91 in the direction of the rotation axis of the drive

With the specified electric component fixed to the substrate so as to protrude outward, the space for arranging the amplifier 92 is enlarged. As a result, a length L of the drive device 91 in the axial direction increases. In this manner, the drive device 91 has a large size in the comparative example.

On the other hand, in the drive device 2 of the present embodiment illustrated in FIG. 2 to FIG. 7, the specified electric component is arranged at the outer side of the electric motor unit 4 in the radial direction. Furthermore, the specified electric component is arranged such that the direction protruding from the substrate is set toward the inner side of the drive device, and thus, the specified electric component can be arranged in the space surrounding the electric motor unit. In this manner, the axial length of the drive device along the drive axis J2 can be reduced. As a result, the drive device 2 can be downsized.

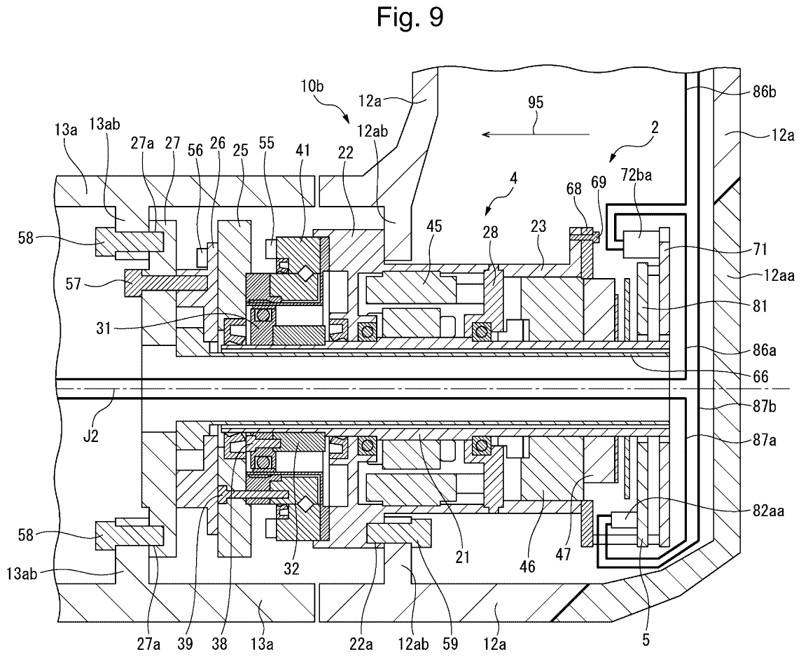

FIG. 9 is an enlarged schematic sectional view of a joint when the drive device of the robot of the present embodiment is arranged at a joint. FIG. 9 is a schematic sectional view of the joint 10b that rotates the upper arm 12 serving as the other component with respect to the turning base 13 serving as one component.

With reference to FIG. 2 and FIG. 9, the torque sensor 27 of the drive device 2 includes a screw hole 27a. A brim 13ab is formed in the housing 13a of the turning base 13. With a bolt 58 fixed to the screw hole 27a, the torque sensor 27 is fixed to the housing 13a. The immovable portion of the drive device 2 is fixed to the turning base 13.

In addition, the housing 22 of the electric motor unit 4 includes a screw hole 22a. A housing 12a of the upper arm 12 includes a brim 12ab having a shape protruding inward. With a bolt 59 inserted to the screw hole 22a, the housing 22 of the drive device 2 is fixed to the housing 12a of the upper arm 12. A turning portion of the drive device 2 is fixed to the upper arm 12.

When the electric motor 45 is driven, the housing 22 rotates together with the elastic cylindrical member 33 of the decelerator 31. Further, the housing 12a of the upper arm 12 fixed to the housing 22 rotates together with the housing 22. As a result, the upper arm 12 rotates around the drive axis J2 with respect to the turning base 13.

The power cable 86a and the communication cable 87a are inserted inside the protective tube 66. The power cable 86a and the communication cable 87a are connected to the drive device arranged in an adjacent joint 10a. With reference to FIG. 4 and FIG. 9, the power cable 86a is connected to the connector 72ba. Further, the power cable 86b is connected to the connector 72bb. The power cable 86b is connected to the drive device arranged in an adjacent joint 10c.

In the plurality of drive devices of the robot 1 of the present embodiment, the information communicated through the communication cables 87a and 87b for performing mutual serial communication may include, in addition to the operation command, information detected by the sensor arranged in the robot 1. The communication cable 87a is connected to the drive device 2 of the connector 82aa. Further, the communication cable 87b connected to the connector 82ab of the drive device 2 is connected to the drive device of the adjacent joint 10c.

In this manner, the drive device 2 is arranged inside the housing of the components of the robot 1. Since the drive device 2 of the present embodiment is small, the joint 10b can be small. In this example, the length of the drive device 2 in the direction of the drive axis J2 can be reduced, and the housing 12a at the joint 10b of the upper arm 12 can be small.

The housing 12a of the upper arm 12 of the present embodiment includes a lid 12aa that is detachable from the body part. The lid 12aa is fixed to the body part of the housing 12a with a fastening member not illustrated in the drawing. The lid 12aa has a size corresponding to the region where the drive device 2 is arranged. It is formed such that the operator can see the entire end portion of the drive device 2 by detaching the lid 12aa. In the present embodiment, the lid 12aa is formed such that the size in the radial direction is greater than the drive device 2. Further, the lid 12aa is formed so as to be larger than the end surface of the amplifier 5.

In the joint 10b of the present embodiment, the amplifier 5 can be separated from the electric motor unit 4 by detaching the bolt 69 with the lid 12aa detached. The amplifier 5 can be integrally removed to the outside of the housing 12a. Further, the amplifier 5 can be removed from the drive device 2 by pulling out the connector from the amplifier 5. In other words, only the amplifier 5 can be detached without detaching the entire drive device 2 from the robot 1. Further, the amplifier can be inspected or replaced. In addition, the drive device 2 can be detached from the housings 12a and 13a by detaching the bolts 58 and 59.

In the present embodiment, the amplifier 5 is arranged at an end portion of the drive device 2, but is not limited to this configuration. Any devices may be arranged at an outer side of the amplifier in the extending direction of the drive axis of the drive device. For example, in some situation, a secondary encoder may be arranged instead of the torque sensor in the drive device. For example, the secondary encoder is connected to a protective tube. The magnitude of torsion of components around the drive axis can be calculated based on the rotation angle output from the primary encoder and the rotation angle output from the secondary encoder. Further, the torque around the drive axis can be calculated based on the magnitude of torsion of the component. Such a secondary encoder may be arranged at the outer side of the amplifier.

The wave gear decelerator is employed as the decelerator in the present embodiment, but is not limited to this configuration. Any decelerators such as a gear decelerator may be employed. In addition, for the decelerator, it is preferable to use a decelerator that can be arranged coaxially with the electric motor with an input shaft and an output shaft arranged on the same line. For example, for the decelerator, a planetary gear decelerator may be employed.

The drive device for driving the components around the drive axis J2 of the robot is described in the present embodiment, but this embodiment is not limitative. The drive device of the present embodiment may be employed for a drive device for driving a given component of the robot.

In addition, the drive device of the robot of the present embodiment is arranged at the joint, but is not limited to this configuration. The drive device of the present embodiment is applicable to any devices for relatively rotating two different members around the rotation axis. For example, the device of the present embodiment is applicable to a drive device arranged at an operation tool so as to drive the components of the operation tool, a drive device that drives an automatic tool replacement device of a machine tool, and the like.

The above embodiments can be combined as appropriate. In each of the above-described drawings, the same or equivalent parts are denoted by the same sign. The above embodiments are examples and do not limit the invention. In addition, the embodiments include the modifications of the embodiments defined in the claims.

1. A drive device comprising:
an electric motor unit including an electric motor; and
an electric motor control unit configured to supply a current to the electric motor, wherein the electric motor control unit includes a substrate having a plate shape, and a plurality of electric components fixed to the substrate,
the substrate is arranged so as to intersect an extending direction of a rotation axis of the electric motor,
the plurality of electric components include a specified electric component with a longitudinal direction provided upright from the substrate, and
the specified electric component is fixed in a direction protruding from the substrate toward an inner side of the drive device, and is arranged more outward than the electric motor unit in a radial direction.

2. The drive device of claim 1, wherein
the electric motor unit includes at least one device selected from a group of a decelerator, a brake, and a rotation position detector, and
the at least one device is arranged side by side with the electric motor in a direction along the rotation axis of the electric motor, and is arranged at an inner side of the specified electric component in the radial direction.

3. The drive device of claim 1, wherein the specified electric component includes at least one member selected from a group of a capacitor, a power device, and a connector configured to connect a wire body to the substrate.

4. The drive device of claim 1, wherein the specified electric component includes at least one connector selected from a group of a connector to which electric power from a power source is input, a connector to which an operation command of the electric motor is input, a connector to which information of a sensor is input, a connector configured to supply electric power to the electric motor, and a connector configured to supply electric power to the brake.

5. A robot comprising:
the drive device of claim 1; and
a joint configured to rotate one component with respect to another component, wherein the drive device is arranged at the joint.
